(19) United States
(12) Patent Application Publication
(10) Pub. No.: US 2020/0002204 A1
(43) Pub. Date: Jan. 2, 2020

(54) METHOD OF REMOVAL AND RECOVERY OF HEXAVALENT CHROMIUM FROM EFFLUENTS BY PASSIVE-ACTIVE BIOLOGICAL PROCESS

(71) Applicant: SYMBIOSIS INTERNATIONAL UNIVERSITY, Maharashtra (IN)

(72) Inventors: Yogesh PATIL, Maharashtra (IN); Nilisha ITANKAR, Maharashtra (IN)

(21) Appl. No.: 16/490,750

(22) PCT Filed: Mar. 3, 2018
(86) PCT No.: PCT/IB2018/051364

§ 371 Date: Sep. 3, 2019

(30) Foreign Application Priority Data
Mar. 3, 2017 (IN) 201721007664

(51) Int. Cl. C02F 3/34; C02F 3/02; C02F 1/00; C02F 1/28

(52) U.S. Cl. CPC C02F 3/34; C02F 3/02; C02F 2101/22; C02F 1/286; C02F 1/004

(57) ABSTRACT

A method of removal and recovery of hexavalent chromium from effluents by passive-active biological process is described. The method may include adsorption of the hexavalent chromium by passive biological process of removal of hexavalent chromium from effluents by adsorbing the hexavalent chromium using a treated and conditioned Limonia acidissima biomass particles. The method may further include conducting bioreduction of the leftover chromium present in the effluent in low concentration by using active bacterial culture for complete removal of hexavalent chromium. The treated and conditioned Limonia acidissima biomass particles having the adsorbed hexavalent chromium may be burnt in a furnace at 400° C. to obtain an ash containing hexavalent chromium. The ash obtained may be mixed with water and filtered to obtain a hexavalent chromium solution which could be recycled and reused.

### TECHNICAL FIELD

This present disclosure relates to a method of removal and recovery of hexavalent chromium from effluents by passive-active biological process, more particularly, by sorption process using passive (dead) Limonia acidissima biomass followed by bioreduction using active (live) bacterial culture.

### BACKGROUND

Chromium is one of the heavy metals discharged from various industries as a part of industrial waste and having high toxicity. The compounds of chromium especially Cr(VI) are known to be detrimental to human beings and animals

Heavy metals pose serious threat to human health and ecology when metal containing effluents are emanated from variety of metal industries. One such heavy metal is Chromium, especially its hexavalent form (VI) which is extremely toxic and is considered to be a human carcinogen by World Health Organization (WHO) and United States Environmental Protection Agency (UNEP) (WHO 1996). Since Cr(VI) being non-renewable metal resource and toxic, its removal from effluents is significantly required. Conventional methods employed for the treatment of Cr(VI) are contemplated with several problems such as efficacy, incomplete removal and cost effectiveness.

Hexavalent chromium is present in the effluents produced during the electroplating, leather tanning, cement, mining, dyeing and fertilizer and photography industries and causes severe environmental and public health problems. The Hexavalent chromium has been reported to be toxic to animals and humans and it is known to be carcinogenic. The concentrations of the Hexavalent chromium in industrial wastewaters ranges from 0.5 to 270.000 mg·l−1. In general, tolerance limit for Cr(VI) that can be discharged into inland surface waters is 0.1 mg·l−1 and that into potable water is 0.05 mg·l−1. In order to comply with the said tolerant limit, it is essential that industries treat the effluents to reduce the Cr(VI) to acceptable levels. In the existing art, number of treatment methods for the removal of metal ions from aqueous solutions have been proposed. Some of these existing treatment methods include reduction, ion exchange, electro dialysis, electrochemical precipitation, evaporation, solvent extraction, reverse osmosis, chemical precipitation and adsorption. Most of these existing methods suffer from drawbacks such as high capital and operational costs or the disposal of the residual metal sludge.

During the chrome tanning process, 40% unused chromium salts are usually discharged in the final effluents, causing a serious threat to the environment. Furthermore, the chrome plating industry is one of the highly polluting industries, the primary effluent consisting of chromium(VI). The chromium(VI) compound is highly toxic to aquatic life and human health. The rinse water constituents reflect the chrome plating bath characteristics; generally dead tank wash water contains about 1% of the plating bath concentration. Other metals and metal compounds usually considered as toxic can be precipitated out by suitably adjusting the pH of the wastewaters. However, Cr(VI) is soluble in almost all pH ranges and therefore an efficient treatment is required for the removal and recovery of chromium, and also for the reuse of wastewaters.

Therefore, there is a long-felt need for process or methods for removal and recovery of hexavalent chromium from industrial matrices.

### SUMMARY

Before the present process and/or method and its use is described, it is to be understood that this disclosure is not limited to the particular process/method as described, as there can be multiple possible embodiments which are not expressly illustrated in the present disclosure but may still be practicable within the scope of the disclosure as determined by claims. It is also to be understood that the terminology used in the description is for the purpose of describing the particular versions or embodiments only and is not intended to limit the scope of the present application. This summary is not intended to identify essential features of the subject matter nor is it intended for use in detecting or limiting the scope of the subject matter.

In an embodiment, a method of removal and recovery of hexavalent chromium from effluents by passive-active biological process is disclosed. The method may include adsorbing hexavalent chromium from effluents by using a treated and conditioned Limonia acidissima biomass particles. The method may further include conducting bioreduction of the leftover hexavalent chromium present in the effluents in low concentration by using active bacterial culture for complete removal of hexavalent chromium. The method may further include burning the treated and conditioned Limonia acidissima biomass particles having the adsorbed hexavalent chromium to obtain an ash containing the hexavalent chromium. The method may further include mixing the ash with distilled water and filtering the solution to obtain a hexavalent chromium solution.

In an embodiment, the treated and conditioned Limonia acidissima biomass particles may be obtained by selecting Limonia acidissima biomass particles of a predefined particle size, preparing an amino acid solution by mixing amino acids in water and in presence of dilute hydrochloric acid, adding the selected Limonia acidissima biomass particles to the prepared amino acid solution to obtain a suspension, shaking the suspension for a predefined amount of time using a suitable shaking means and filtering the suspension to obtain the treated and conditioned Limonia acidissima biomass particles.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a method 100 of obtaining the hexavalent chromium from the effluents discharged by various industries having chromium as an element for their particular usage.

FIG. 2 illustrates a method 200 of obtaining the treated and conditioned Limonia acidissima biomass particles in accordance with an embodiment of the present disclosure.

### DETAILED DESCRIPTION

The present disclosure relates to a method of removal and recovery of hexavalent chromium from effluents by passive-active biological process, more particularly, by sorption process using passive (dead) Limonia acidissima biomass followed by bio reduction using active (live) bacterial culture.

It must be noted that Limonia acidissima biomass is used or implemented in the current disclosure in the form of biomass particles in accordance with embodiments of the present disclosure. Limonia acidissima has a common name as Wood Apple Shell. Therefore, Limonia acidissima will be interchangeably referred as Wood Apple Shell and or Wood Apple Shell Powder in the current disclosure. Further, hexavalent chromium may also be referred as Cr(VI) in the current disclosure.

In accordance with embodiments of the present disclosure, the treatment of waste water effluents may initially include utilisation of dead (passive) biomass on real effluent collected from numerous sources containing hexavalent chromium (also referred as Cr(VI) hereinafter in the subsequent paragraphs of the description). The method may further include bio reduction using active (live) bacterial culture. The bio reduction may further include bacterial reduction of Cr(VI) which occurs in the presence of external source of carbon and nitrogen under microaerophilic or aerobic conditions. Since chromium naturally exists in the form of Chromate (CrO₄⁻²), the particular species present in the active (live) bacterial culture may act an electron acceptor to the bacteria thereby reducing it to insoluble trivalent form of chromium [Cr(III)]. The above sub-methods together may result in removal and recovery of Cr(VI).

It must be noted that the industrial effluents are in form of an unknown matrix and may further contain diverse range of cations and anions. Implementation of Limonia acidissima biomass in the presence of all interfering metals ions present in industrial effluent may further prove efficient to remove 50 mg/l of Cr(VI) with an efficiency of >99%. In an experiment, after equilibrium and dynamics studies, it was observed in column studies that 50 mg/l concentrated waste water when passed through a column of 30 cm (bed height), Cr(VI) concentration in the effluent was reduced to zero for almost 30-50 cycles of solution.

In the above embodiment, the rest of the effluents were subjected to bio reduction with bacterial culture for complete removal of Cr(VI). The saturated biomass after sorption was heated at 400° C. temperature in muffle furnace for 3 hours, the ash obtained was dissolved in distilled water and filtered to obtained concentrated Cr(VI) solution which could be recycled back and used in electroplating bath.

In accordance with embodiments of the present disclosure, the removal of the Cr(VI) is enabled by sorption using dead biomass having suitable functional groups. This may ensure removal of >99% of Cr(VI). Once sorption is complete, recovery of Cr(VI) is possible. The unrecoverable traces of Cr(VI) then may be subjected to bio reduction using bacterial culture. In an embodiment, under optimal conditions, the time required for hexavalent chromium sorption by Limonia acidissima biomass particles is approximately one hour.

Thus, the proposed invention focuses sorption of Cr(VI) using waste bio sorbent and recovery of the Cr(VI) from biomass such that Cr(VI) can be re-used in industry. Further, the proposed invention enables in bio reduction of left over chromium in the solution using live microbial culture. This is the last step (polishing step) to remove traces of Cr(VI), if any, which are left over after sorption step.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. The present disclosure can be embodied in many other forms or carried out in other ways, without departing from the spirit or essential characteristics thereof, and the above-mentioned embodiment of the disclosure have been disclosed in detail only for illustrative purposes. It is understood that the disclosure is not limited thereto but is susceptible of numerous changes and modifications as known to those skilled in the art, and all such variations or modifications of the disclosed apparatus, including the rearrangement of parts, lie within the scope of the present disclosure.

The foregoing description shall be interpreted as illustrative and not in any limiting sense. A person of ordinary skill in the art would understand that certain modifications could come within the scope of this disclosure.

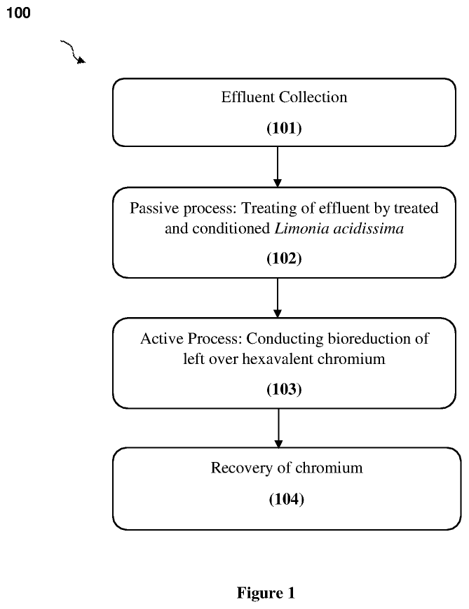

FIG. 1 illustrates a method 100 of obtaining the hexavalent chromium from the effluents discharged by various industries having chromium as an element for their particular usage.

Hexavalent chromium because of its unique properties finds large number of industrial applications. Industries like tannery cement, mining, dyeing and fertilizer and photography discharge large quantities of chromium containing effluents. Since chromium is a known mutagen and carcinogen, the pollution laws in most countries require its complete removal from waste streams before discharge.

As shown in FIG. 1, at step 101, effluents containing chromium from the industries is transferred to canals or to large tanks where such effluents can be treated before releasing them in aquatic bodies. Such collection may be in-house or can be collected at place or warehouse away from the industry where such warehouse may accept effluents from all the industries and further combines the effluent to get a greater amount hexavalent chromium.

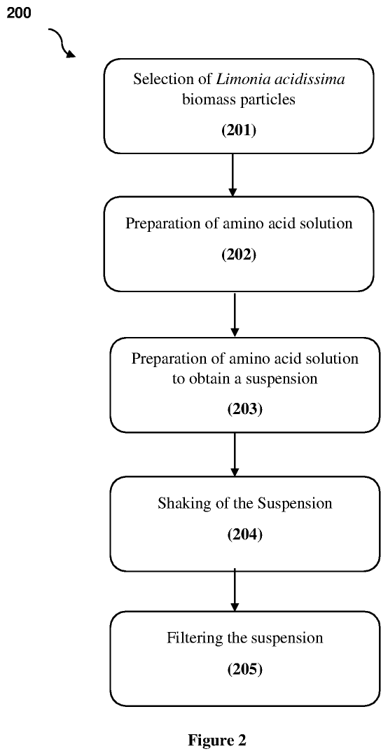

At step 102, the effluents are treated with passive biological process, wherein the biological process may include treating the collected effluent by treated and conditioned Limonia acidissima biomass particles. The detailed process of obtaining the treated and conditioned biomass particles is illustrated in FIG. 2 and explained later in subsequent paragraphs. The conditioned Limonia acidissima biomass particles adsorbs the hexavalent chromium. The adsorption efficiency of the Limonia acidissima biomass particles is increased by treating and conditioning the dead Limonia acidissima particles.

In an embodiment, the conditioned or treated biomass showed >99% adsorption capacity from pH (1 to 4), while at pH 5.0 and 6.0 the biosorption was greater than 95% (See Table 1). In other words, excellent sorption capacity was seen at wide range of pH. Such treatment enhanced the adsorption capacity (loading capacity) of Limonia acidissima biomass to 35.23 mg/g.

In a preferred embodiment, under optimal conditions the time required for sorption process by Limonia acidissima biomass particles may be one hour approximately.

At step 103, the effluents are treated with active biological process. The effluent is the left-over effluent still having little traces of hexavalent chromium which was not captured by the passive process. Therefore, to reduce the little traces of hexavalent chromium in the effluent, the left-over effluent is treated with active (live) bacterial culture. Such live biomass particles are capable of reducing hexavalent chromium metal to trivalent chromium by bioreduction process.

At step 104, the dead Limonia acidissima biomass particles which have adsorbed the hexavalent chromium particles are dried in a furnace at 400° C. for 3 hours. The ash obtained from the furnace is dissolved in distilled water and filtered to obtain concentrated hexavalent chromium solution which may be recycled back in the industries mentioned above.

Now referring to FIG. 2, a method 200 of obtaining the treated and conditioned Limonia acidissima biomass particles is illustrated, in accordance with an embodiment of the present disclosure.

At step 201, the dried and dead Limonia acidissima biomass particles of size below 250 micro meters are selected.

At step 202, an amino acid solution is prepared by using sulphur containing amino acid solution. The sulphur containing amino acid solution may include L-cysteine and methionine. These compounds are mixed in water with the presence of dilute hydrochloric acid. The resultant homogeneous mixture forms the amino acid solution.

At step 203, the selected Limonia acidissima biomass particles may be mixed with the prepared amino acid solution as described in step 203. The mixing of biomass particles in the amino acid solution forms a suspension.

At step 204, the suspension obtained is rotated in a suitable shaking means for at least 2 hours. In one embodiment, the suitable shaking means may be an industrial rotary shaker.

At step 205, the suspension is filtered using a suitable filter material to obtain the treated and conditioned Limonia acidissima biomass particles.

In an embodiment, the treated and conditioned Limonia acidissima biomass particles have more capacity of adsorption as compared to normal dried Limonia acidissima biomass particles. The following Table 1 shows the adsorption efficiency for different type of Limonia acidissima biomass particles.

TABLE 1
Effect of pH on adsorption capacity of conditioned and non-conditioned biomass

| Biomass | | | | | | | | | |
|---|---|---|---|---|---|---|---|---|---|
| (conditioned & non- | pH | | | | | | | | |
| conditioned) | 1 | 2 | 3 | 4 | 5 | 6 | 7 | 8 | 9 |
| WASP (non-conditioned) | 97% | 98% | 99% | 99% | 95% | 90% | 76% | 60% | 51% |
| L-Cysteine treated WASP | 97% | 98% | 99% | 99% | 93% | 91% | 78% | 65% | 52% |
| (Conditioned) | | | | | | | | | |
| WASP treated with L- | 99% | 99% | 99.8% | 99.9% | 98.5% | 95% | 84% | 72% | 60% |
| Cysteine + methanoine + | | | | | | | | | |
| HCl (Conditioned) | | | | | | | | | |

Table 1 shows the effect of solution pH on biosorption of Cr(VI) by Limonia acidissima biomass. It is observed that for all three biomasses there is a consistent (>99%) adsorption of Cr(VI) from pH 1 to 4. However, the biomass conditioned with L-cysteine, methanoine and HCl showed sorption at wide range of pH with higher sorption capacity.

In an embodiment, it was revealed that in acidic medium, the biosorption efficiency increased with the increase in solution pH (i.e. from pH 1.0 to 4.0) for all the three-biomass tested. The percent sorption of Cr(VI) was found to increase from 97 to 99% and then steadily decreased with rise in pH. It was interesting to note that the WASP biomass showed consistent higher sorption capacity (>90%) for wide range of pH (1.0 to 6.0) at 10 and 50 mg/L.

It must be noted that, pH influences the solution chemistry of the metal, therefore it may further change the performance of functional group present on the biomass and the surface charge by interactive dissociation and association on active site of the sorbent (Ahalya et al., 2005). At acidic pH, the dominant form of chromium species that exist in solution are

CrO42—, HCrO4— and Cr2O72—. In the acidic conditions, the biomass due to protonation becomes positively charged and chromium being oxyanion and negatively charged shows electrostatic attraction (Boddu et al., 2008; Cimino et al., 2000; Qaiser et al., 2009). With increase in pH, the adsorption of Cr(VI) ions decreases due to repulsive forces between the biosorbent and Cr(VI) ions. At solution pH 8.0 and above, CrO42— is the only dominant species that can prevail. Therefore, there is a shift in the equilibrium, as the pH changes from acidic to basic. In the pH range of 1.0 to 6.0, chromium species like HCrO4— and Cr2O72— are in equilibrium, which leads to the formation of maximum polymerized chromium oxide species on the surface of biomass (Ahalya et al., 2006). Effluents emanated from chromium user industries generally have pH ranging from 0.5 to 4.0 (Aravindhan et al., 2014; Martin-Lara et al., 2014; Santhosh and Sridevi, 2013). In the present invention, the optimum pH for Cr(VI) sorption by Limonia acidissima was observed to be 4.0. Therefore, no or minimal pH adjustment of the effluents would be required prior to biosorption saving cost and resources. Further, it was found that the inherent pH of Limonia acidissima biomass was 4.04 and therefore from practical viewpoint no prior conditioning of biomass would be required again saving cost and resources.

The Cr(VI) loading capacity (mg/g) bound per gram weight of the biosorbent powder was determined by contacting 1 g biosorbent powder several times with fresh batches of 50 mL Cr(VI) solution (50 mg/L) having pH 4.0 at a particle size ≤250, till saturation was achieved. Each cycle of contact was operated for one-hour duration. The results of loading capacity of biomass are depicted in Table 2.

In yet another embodiment, a comparative study was carried out on loading capacity of plain Limonia acidissima, L-Cysteine treated Limonia acidissima and Limonia acidissima treated with L-Cysteine, Methanoine and HCl. The results of loading capacity are given in Table 2

TABLE 2
Comparative result of loading capacity of biomass

| | | Limonia acidissima treated |
|---|---|---|
| Limonia | L-Cysteine treated | with |
| acidissima | Limonia acidissima | L-Cysteine & Methanoine |
| 29.37 mg/g | 33.25 mg/g | 35.23 mg/g |

*All values given in the table are the average of two readings;

The loading capacity of plain Limonia acidissima is higher in current study as compared to normal study because of pH conditioning of biomass before subjecting it to Cr(VI) biosorption. In other two biomasses due to pre-treatment it was observed that its sorption capacity increased, more particularly in Limonia acidissima treated with L-Cysteine, Methanoine and HCl.

The metal loading capacity/ability of the biomass could be taken equivalent to number of binding sites present on biomass. Several researchers have reported the adsorption capacity (mg/g) of diverse range of biomaterials (Ahalya et al., 2006; Gupta and Babu, 2006; Selvi et al., 2001). In general, the reported loading capacity ranges from 0.2 mg/g to 125 mg/g (Masriet al., 1974; Sumathi et al., 2005).

Although implementations for have been described in language specific to structural features and/or methods, it is to be understood that the appended claims are not necessarily limited to the specific features or methods described. Rather, the specific features and systems are disclosed as examples of implementations of method for the removal and recovery of Cr(VI) from effluents by passive-active biological process.

1. A method of removal and recovery of hexavalent chromium from effluents by passive-active biological process, the method comprising:
adsorbing hexavalent chromium from effluents using a treated and conditioned Limonia acidissima biomass particles;
conducting bioreduction of the leftover hexavalent chromium present in the effluents in low concentration by using active bacterial culture for complete removal of the hexavalent chromium;
burning the treated and conditioned Limonia acidissima biomass particles having the adsorbed hexavalent chromium to obtain Mean ash containing hexavalent chromium; and
mixing the ash with distilled water and filtering the solution to obtain a hexavalent chromium solution.

2. The method according to claim 1, wherein the treated and conditioned Limonia acidissima biomass particles is obtained by:
selecting Limonia acidissima biomass particles of a predefined particle size;
preparing an amino acid solution by mixing amino acids in water and in presence of dilute hydrochloric acid;
adding the selected Limonia acidissima biomass particles to the prepared amino acid solution to obtain a suspension;
shaking the suspension for a predefined amount of time using a suitable shaking means; and
filtering the suspension to obtain the treated and conditioned Limonia acidissima biomass particles.

3. The method according to claim 1, wherein the hexavalent chromium is recovered from the adsorbed hexavalent chromium on the treated and conditioned Limonia acidissima biomass particles.

4. The method according to claim 2, wherein the predefined particle size for selecting the Limonia acidissima biomass particles is less than or equal to 250 micro meters.

5. The method according to claim 2, wherein the amino acids selected for preparation of the amino acid solution are sulphur based amino acids.

6. The method according to claim 5, wherein the amino acids selected for preparation of the amino acid solution are L-cysteine and methionine.

7. The method according to claim 1, wherein an optimum pH for hexavalent chromium sorption by Limonia acidissima is 4.0 and an inherent pH of Limonia acidissima is 4.04.

8. The method according to claim 1, wherein the bioreduction of hexavalent chromium occurs in the presence of an external source of carbon and nitrogen under microaerophilic or aerobic conditions, and wherein hexavalent chromium reduces to trivalent chromium.

9. The method according to claim 1, wherein the treated and conditioned Limonia acidissima biomass particles having the adsorbed hexavalent chromium is burnt in furnace at 400° C.

10. The method according to claim 2, wherein the treated and conditioned Limonia acidissima biomass particles produced a loading capacity of 35.23 mg/g.
